(19) United States
(12) Patent Application Publication
(10) Pub. No.: US 2025/0296566 A1
(43) Pub. Date: Sep. 25, 2025

(54) CONTROL DEVICE FOR VEHICLE

(71) Applicant: TOYOTA JIDOSHA KABUSHIKI KAISHA, Toyota-shi (JP)

(72) Inventors: Akio MURASUGI, Toyota-shi (JP); Kengo NAGAI, Toyota-shi (JP)

(73) Assignee: TOYOTA JIDOSHA KABUSHIKI KAISHA, Toyota-shi (JP)

(21) Appl. No.: 19/016,316

(22) Filed: Jan. 10, 2025

(30) Foreign Application Priority Data
Mar. 22, 2024 (JP) 2024-047272

(51) Int. Cl. B60W 30/16; B60W 10/02; B60W 60/00

(52) U.S. Cl. CPC B60W 30/16; B60W 10/026; B60W 60/00; B60W 2510/0233; B60W 2554/4041; B60W 2554/4042; B60W 2554/802; B60W 2710/024

(57) ABSTRACT

The electronic control unit includes: an automated drive control unit that performs automated driving control; an predicted attainment period calculation unit that calculates an inter-vehicle distance or a predicted attainment period of the inter-vehicle distance or the vehicle speed until the inter-vehicle distance or the target vehicle speed is reached, when LU clutch is in an engaged state while the automated driving is in progress; and a first connection/disconnection control unit that performs control to switch LU clutch to the released state when the inter-vehicle distance or the vehicle speed is larger than a preset target attainment period, and to continue the engaged state of LU clutch when the inter-vehicle distance or the vehicle speed is equal to or smaller than the target attainment period.

### CROSS-REFERENCE TO RELATED APPLICATION

This application claims priority to Japanese Patent Application No. 2024-047272 filed on Mar. 22, 2024, incorporated herein by reference in its entirety.

### BACKGROUND

### 1. Technical Field

The present disclosure relates to a control device for a vehicle equipped with a torque converter with a lockup clutch, and an automated driving function.

### 2. Description of Related Art

There is disclosed technology in which, in a vehicle equipped with a torque converter with a lockup clutch and an automated driving function, variance in vehicle speed is suppressed when the lockup clutch is in an engaged state and also traveling by automated driving is being performed. An example thereof is a vehicle control device described in Japanese Unexamined Patent Application Publication No. 2019-214247 (JP 2019-214247 A).

### SUMMARY

Now, during automated driving of the vehicle, not only is variance in vehicle speed suppressed, but also driving force control is performed in accordance with a roadway. For example, an inclination angle of a road is acquired from map data, and when the road ahead to be traveled on is an uphill road, control for increasing driving force in advance in accordance with the inclination angle is performed. In such a case, when the lockup clutch is in the engaged state and the driving force is insufficient, switching the lockup clutch to a disengaged state and increasing the driving force by torque amplification of the torque converter becomes necessary. However, engaging and disengaging control of the conventional lockup clutch is performed based on accelerator operation amount and the vehicle speed at the present point in time, and accordingly the switching of the lockup clutch to the disengaged state is not immediately performed, and as a result, a delay occurs in increasing the driving force. That is to say, the engaging and disengaging control of the lockup clutch is not optimal control in accordance with automated driving, and there is room for improvement in the engaging and disengaging control of the lockup clutch when traveling by automated driving.

The present disclosure has been made in view of the above circumstances, and an object thereof is to provide a control device of a vehicle, that optimally performs engaging and disengaging control of a lockup clutch during traveling by automated driving.

According to an aspect of the present disclosure,
(a) a control device for a vehicle equipped with a torque converter with a lockup clutch includes
(b) an automated drive control unit that controls travelling by automated driving, a predicted attainment period calculating unit that, when the vehicle is undergoing the travelling by automated driving and also the lockup clutch is in an engaged state, calculates a predicted attainment period required for an inter-vehicle distance to a vehicle traveling ahead or a vehicle speed to attain a target inter-vehicle distance or a target speed, and a first engaging and disengaging control unit that performs control to switch the lockup clutch to a disengaged state when the predicted attainment period is greater than a target attainment period that is set in advance, and to maintain the engaged state of the lockup clutch when the predicted attainment period is no greater than the target attainment period.

A control device for a vehicle of the present disclosure includes an automated drive control unit that controls travelling by automated driving, a predicted attainment period calculating unit that, when the vehicle is undergoing the travelling by automated driving and also the lockup clutch is in an engaged state, calculates a predicted attainment period required for an inter-vehicle distance to a vehicle traveling ahead or a vehicle speed to attain a target inter-vehicle distance or a target speed, and a first engaging and disengaging control unit that performs control to switch the lockup clutch to a disengaged state when the predicted attainment period is greater than a target attainment period that is set in advance, and to maintain the engaged state of the lockup clutch when the predicted attainment period is no greater than the target attainment period. Accordingly, when it is predicted that the target inter-vehicle distance or the target vehicle speed cannot be attained within the target attainment period, the lockup clutch is switched to the disengaged state, and accordingly the driving force is increased by torque amplification action of the torque converter, and the attainment period is shortened. Thus, the engaging and disengaging control of the lockup clutch is optimally performed during traveling by automated driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a schematic configuration of a vehicle to which the present disclosure is applied, and is a diagram for explaining main parts of a control function and a control system for various kinds of control in the vehicle;

FIG. 2 is an example of a lockup switching map determined in advance as a connection and disconnection condition of the lockup clutch;

FIG. 3 is an exemplary flow chart for explaining the control operation of the lockup clutch engagement and disengagement control of the electronic control unit shown in FIG. 1 during automated driving; and

FIG. 4 is an example of a flowchart for explaining the control operation of the lockup clutch engagement/disengagement control in the case where the traveling mode of the electronic control unit shown in FIG. 1 is changed during the automated driving.

### DETAILED DESCRIPTION OF EMBODIMENTS

Hereinafter, an embodiment of the present disclosure will be described in detail with reference to the drawings. Note that, in the embodiments, the drawings are simplified or modified as appropriate, and the dimensional ratios, shapes, and the like of the respective portions are not necessarily drawn accurately.

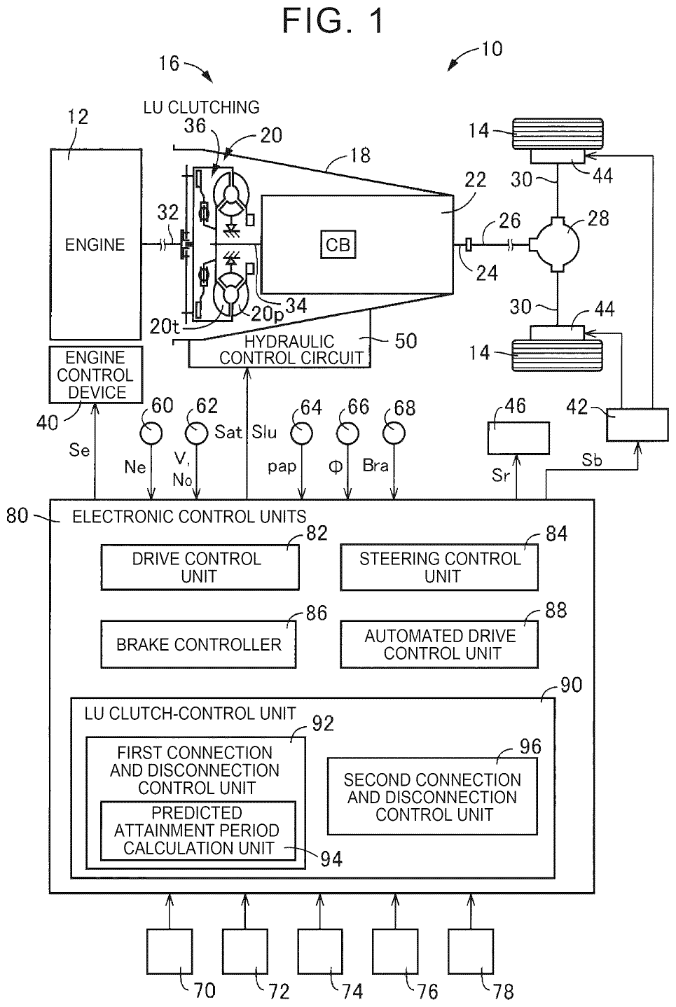

FIG. 1 is a diagram for describing a schematic configuration of a vehicle 10 to which the present disclosure is applied, and for describing a main part of a control function for various kinds of control in the vehicle 10. In FIG. 1, a vehicle 10 includes an engine 12 as a power source, wheels 14, and a power transmission device 16 provided in a power transmission path between the engine 12 and the wheels 14. The power transmission device 16 includes a torque converter 20, an automatic transmission 22, and the like in the case 18. The power transmission device 16 includes a propeller shaft 26 connected to a transmission output shaft 24 which is an output rotation member of the automatic transmission 22, a differential 28 connected to the propeller shaft 26, a left and right drive shafts 30 connected to the differential 28, and the like.

In the engine 12, an output torque of the engine 12 is controlled by controlling an engine control device 40 provided in the vehicle 10 by an electronic control unit 80 described later.

The torque converter 20 is disposed in a power transmission path between the engine 12 and the automatic transmission 22, and is connected to the engine 12 via a crankshaft 32. The torque converter 20 includes a pump impeller 20p, a turbine impeller 20t, and the like, and further includes a lockup clutch (hereinafter referred to as a LU clutch) 36 that connects the pump impeller 20p and the turbine impeller 20t.

The automatic transmission 22 is coupled to the engine 12 via a torque converter 20 and an input shaft 34. Automatic transmission 22 is a known planetary gear type stepped transmission capable of selecting a plurality of gear stage POSsh including, for example, a plurality of sets of planetary gears and a plurality of hydraulic engagement device CB such as clutches and brakes.

The vehicle 10 further includes a brake control device 42 and a steering control device 46. The brake control device 42 controls the braking force of the brakes 44 for braking the wheels respectively provided on the wheels 14. The steering control device 46 controls the steering angle of the wheels 14.

The vehicle 10 includes an electronic control unit 80 as a controller of the vehicle 10. The electronic control unit 80 is supplied with various signals (for example, the engine rotational speed Ne (rpm), AT output rotational speed No (rpm corresponding to the vehicle speed V (Km/h), the accelerator operation amount pap (%), the steering angle Φ, the brake operation amount Bra of the brake pedal, and the like, which are provided in the vehicle 10 and are based on the detected values by the engine rotational speed sensor 60, the output rotational speed sensor 62, the accelerator operation amount sensor 64, the steering angle sensor 66, the brake operation amount sensor 68, and the like. The accelerator operation amount pap corresponds to an accelerator operation of the driver with respect to the vehicles 10.

The automated driving setting switch 70 is a switch for setting automated driving. The automated driving includes full autonomous traveling in which the driving force and the steering angle θ of the vehicle 10 are automatically controlled and traveled, and cruise traveling in which constant speed or follow-up traveling is performed without requiring an acceleration/deceleration operation by the driver. Either full automated driving or cruise driving is set by the driver's operation. The navigation system 72 is a device that includes map information and displays or sets a travel route according to a destination, and acquires various types of road traffic information such as a vehicle position, a traffic jam, a road, a gradient, an altitude, a statutory speed, and weather by using GPS, VICS (registered trademark) (Vehicle Information and Communication System; a road traffic information communication system). The radar 74 is a device that detects an inter-vehicle distance between a preceding vehicle and a rear vehicle, or a distance between a nearby passerby person or an obstacle. The camera 76 is a device that captures an image of a front side, a rear side, or the like of the vehicle. The travel mode setting switch 78 is a switch for setting a travel mode of the vehicle 10. The driving mode includes a sport mode for increasing the driving force during traveling, a power mode, an eco mode for decreasing the driving force during traveling, and the like, and is set by the driver's operation. Signals representing the respective information of the device and the switch are also supplied to the electronic control unit 80.

From the electronic control unit 80, various command signals (for example, an engine control command signal Se for controlling the engine 12, a brake control command signal Sb for controlling the braking force of the brake 44, a steering angle command signal Sr for controlling the steering angle of the wheels 14, a hydraulic control command signal Slu for controlling the operating state of the hydraulic control command signal Sat, LU clutch 36 for controlling the operating state of the engagement device CB, and the like) are respectively outputted to the engine control device 40, the brake control device 42, the steering control device 46, the hydraulic control circuit 50, and the like provided in the vehicle 10.

The electronic control unit 80 functionally includes a drive control unit 82, a steering control unit 84, a brake control unit 86, an automated drive control unit 88, and a LU clutch control unit 90. LU clutch-control unit 90 functionally includes a first connection-and-disconnection control unit 92 and a second connection-and-disconnection control unit 96. Furthermore, the first connection/disconnection control unit 92 functionally includes a predicted attainment period calculation unit 94.

The drive control unit 82 controls the engine 12. The drive control unit 82 calculates the required driving force F by applying the accelerator operation amount pap and the vehicle speed V to a predetermined driving force map. The drive control unit 82 outputs an engine control command signal Se for realizing the required driving force F to the engine control device 40. When the automated driving is set, the drive control unit 82 outputs the engine control command signal Se to the engine control device 40 so as to be the target required driving force Ft supplied from the automated drive control unit 88, which will be described later.

The drive control unit 82 performs shift control of the automatic transmission 22. For example, the drive control unit 82 determines the gear stage POSsh of the automatic transmission 22 using, for example, a shift map that is a predetermined relation. The drive control unit 82 outputs a hydraulic control command signal Sat for switching the operation status of the engagement device CB so as to form the determined gear stage POSsh to the hydraulic control circuit 50.

The steering control unit 84 controls the steering angle θ of the wheel 14. The wheel 14 outputs the steering angle command signal Sr to the steering control device 46 so that the steering angle ′ corresponds to the steering angle Φ supplied from the steering angle sensor 66. Further, when the full autonomous travel of the automated driving is selected, the steering control unit 84 outputs the steering angle command signal Sr to the steering control device 46 so as to be the target steering angle θt supplied from the automated drive control unit 88 which will be described later.

The brake control unit 86 controls the braking force β of the brake 44 for braking the wheels respectively provided on the wheels 14. The brake control command signal Sb is outputted to the brake control device 42 so as to become the braking force β corresponding to the brake operation amount Bra supplied from the brake operation amount sensor 68. When the automated driving is set, the brake control unit 86 outputs the brake control command signal Sb to the brake control device 42 so as to be the target braking force βt supplied from the automated drive control unit 88 described later.

When the automated driving is set, the automated drive control unit 88 controls the full automated driving or the cruise driving according to the setting. When full automatic travel is set, the automated drive control unit 88 creates a travel plan of the vehicle 10 along the target route set by the driver, based on, for example, vehicle position information, map information, travel route information from the navigation system 72, information such as an inter-vehicle distance between the preceding vehicle and the rear vehicle from the radar 74, and the like.

The automated drive control unit 88 sequentially sets the target vehicle speed Vt and the target inter-vehicle distance Dt with respect to the preceding vehicle on the basis of the travel plan of the vehicle 10, the aforementioned map information, and the like, and further calculates the target required driving force Ft and the target braking force βt for realizing the target vehicle speed Vt and the target inter-vehicle distance Dt. Further, when the cruise travel is set, the target vehicle speed Vt and the target inter-vehicle distance Dt are set by the driver, and the automated drive control unit 88 calculates the target required driving force Ft and the target braking force βt on the basis of the set target vehicle speed Vt and the target inter-vehicle distance Dt. Further, the automated drive control unit 88 supplies the target required driving force Ft to the drive control unit 82 and the predicted attainment period calculation unit 94, and supplies the target braking force βt to the brake control unit 86.

When the full automatic travel is set, the automated drive control unit 88 supplies the target steering angle θt to the steering control unit 84. The target steering angle θt is determined based on information from the navigation system 72 and the camera 76. For example, the vehicle travels in accordance with a predetermined travel route, travels along a lane or the like detected by the camera 76, or switches lanes, and is appropriately set in accordance with the vehicle speed V, the required driving force F, or the like.

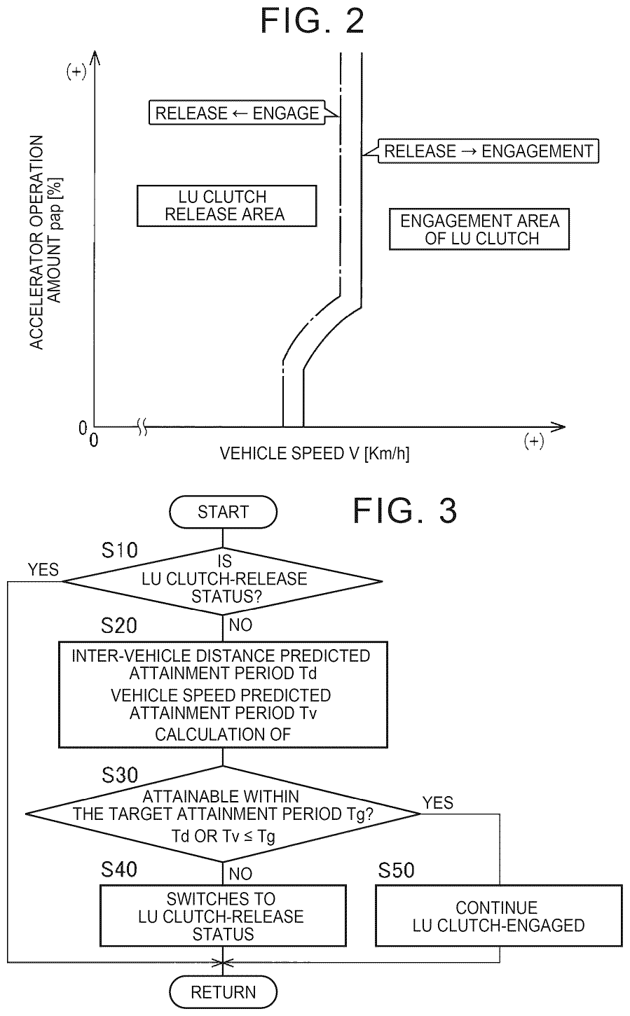

LU clutch control unit 90 applies the vehicle traveling state represented by the vehicle speed V and the accelerator operation amount pap to a predetermined lockup operation region map, and thereby outputs the hydraulic control command signal Slu to the hydraulic control circuit 50 so that LU clutch 36 is brought into and out (released state or engaged state). FIG. 2 is an exemplary lock-up switching map that is determined in advance as the connection/disconnection condition of LU clutch 36. In FIG. 2, the engagement/disengagement state of LU clutch 36 is set based on the vehicle state of the vehicle 10 represented on the two-dimensional coordinates of the vehicle speed V and the accelerator operation amount pap. In the lock-up switching map, AT power rotational speed No or the like may be used instead of the vehicle speed V, or the required driving force For the like may be used instead of the accelerator operation amount pap.

In the lock-up switching map, an “engagement→release” switching line (switching from the engagement state to the release state of LU clutch 36) and a “release→engagement” switching line (switching from the release state to the engagement state of LU clutch 36) are determined in advance. For example, when the point represented by the vehicle speed V and the accelerator operation amount pap in FIG. 2 crosses the “engagement→release” switching line or the “release→engagement” switching line, it is determined that the release control or the engagement control of LU clutch 36 is started.

In addition, LU clutch control unit 90 performs connection/disconnection control of a lockup clutch, which will be described later, in the first connection/disconnection control unit 92 (including the predicted attainment period calculation unit 94) and the second connection/disconnection control unit 96, which are functionally included in LU clutch control unit 90 during automated driving.

FIG. 3 is an example of a flowchart for explaining a control operation of the first connection/disconnection control unit 92 (including the predicted attainment period calculation unit 94) functionally included in the electronic control unit 80. The flowchart of FIG. 3 is repeatedly executed during the automated driving. Hereinafter, the control operation will be described along the processing step of FIG. 3.

First, in a step (hereinafter, step is omitted) S10 corresponding to the function of the first connection/disconnection control unit 92, it is determined whether or not LU clutch 36 is released. If S10 determination is affirmative, the routine is terminated.

When the determination of S10 is negative, the inter-vehicle distance predicted attainment period Td or the vehicle speed predicted attainment period Tv is calculated in S20 corresponding to the function of the predicted attainment period calculation unit 94. The inter-vehicle distance predicted attainment period Td is a period required until the inter-vehicle distance D at the present point in time attains the target inter-vehicle distance Dt. The inter-vehicle distance predicted attainment period Td is a period required until the vehicle speed V at the present point in time attains the target vehicle speed Vt. The inter-vehicle distance predicted attainment period Td and the vehicle speed predicted attainment period Tv correspond to the “predicted attainment period” of the present disclosure.

The inter-vehicle distance predicted attainment period Td and the vehicle speed predicted attainment period Tv are calculated as follows, for example. First, the predicted acceleration Ap is calculated on the basis of the displacement range ΔFt from the driving force at the present point in time to the target required driving force Ft, the traveling road information (gradient, road surface condition) to be traveled from now, the information (weight, traveling resistance, and the like) of the vehicle 10, and the like. Then, the vehicle speed predicted attainment period Tv is given as a solution of the following Expression (1) with time t as a variable, and is calculated by the following Expression (2).

$$Ap \times t = \vert V - Vt \vert \qquad ( 1 )$$

$$Vehicle speed predicted attainment period Tv = ( \vert V - Vt ) / Ap \qquad ( 2 )$$

Further, the inter-vehicle distance predicted attainment period Td is given as a solution of the following Expression (3) with time t as a variable, and is calculated by the following Expression (4).

$$\int Ap \times {t}^{2} dt = \vert D - Dt \vert \qquad ( 3 )$$

$$Inter - vehicle distance predicted attainment period Td = {( ( 3 \times \vert D - Dt \vert ) / Ap )}^{1 / 3} \qquad ( 4 )$$

In addition, the inter-vehicle distance predicted attainment period Td and the vehicle speed predicted attainment period Tv include the predicted acceleration Ap and |V−Vt|, |D−Dt| in addition to the above-described calculation formulas It may be calculated in other suitable ways, such as applying a value such as to a pre-prepared map. Further, the predicted acceleration Ap may be calculated as the time-function Ap=Ap(t), and the inter-vehicle distance predicted attainment period Td and the vehicle speed predicted attainment period Tv may be calculated by suitable methods for obtaining the time t.

Next, in S30 corresponding to the function of the first connection/disconnection control unit 92, it is determined whether or not the inter-vehicle distance predicted attainment period Td or the vehicle speed predicted attainment period Tv calculated by S20 is equal to or less than the target attainment period Tg. That is, it is determined whether or not the target inter-vehicle distance Dt or the target vehicle speed Vt can be attained within the target attainment period Tg. The target attainment time Tg is a value set in advance by designing or experimentally. The target attainment time Tg may be set separately for each of the inter-vehicle distance predicted attainment period Td and the vehicle speed predicted attainment period Tv. In the determination of S30, the determination may be affirmative when any one of the inter-vehicle distance predicted attainment period Td and the vehicle speed predicted attainment period Tv is equal to or less than the target attainment period Tg, or may be affirmative when any one of the predetermined values is equal to or less than the target attainment period Tg.

When the determination of S30 is negative, LU clutch 36 is switched to the release status in S40 corresponding to the function of the first connection/disconnection control unit 92. When the determination of S30 is affirmative, the engagement of LU clutch 36 is continued in S50 corresponding to the function of the first connection/disconnection control unit 92. After S40 and after S50 are executed, the routine is terminated.

When it is predicted that the target inter-vehicle distance Dt or the target vehicle speed Vt cannot be attained within the target attainment period Tg due to the control operation of the first connection/disconnection control unit 92, LU clutch 36 is switched to the released state, so that the driving force is increased by the torque amplifying action of the torque converter 20 and the attainment period is shortened. Therefore, during automated driving, the connection/disconnection control of LU clutch 36 is optimally performed.

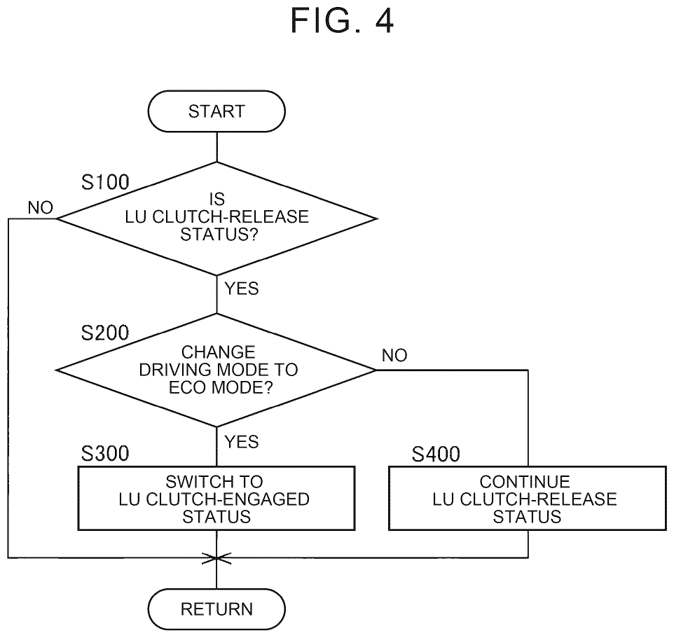

FIG. 4 is an example of a flowchart for explaining a control operation of the second connection/disconnection control unit 96 functionally included in the electronic control unit 80. The flowchart of FIG. 4 is repeatedly executed during the automated driving. Hereinafter, the control operation will be described along the processing step of FIG. 4.

First, in a step (hereinafter, step is omitted) S100 corresponding to the function of the second connection/disconnection control unit 96, it is determined whether or not LU clutch 36 is released. If S100 determination is affirmative, the routine is terminated.

When the determination of S100 is affirmative, it is determined by the driver whether or not the driving mode has been changed to the eco-mode in which the driving force at the time of traveling is reduced in S200 corresponding to the function of the second connection/disconnection control unit 96.

When the determination of S200 is affirmative, LU clutch 36 is switched to the engaged condition in S300 corresponding to the function of the second connection/disconnection control unit 96. When the determination of S200 is negative, LU clutch 36 continues to be released at a S400 corresponding to the function of the second connection/disconnection control unit 96. After S300 and after S400 are executed, the routine is terminated.

When the driving mode is changed to the eco-mode in which the driving force at the time of traveling is reduced by the control operation of the second connection/disconnection control unit 96, LU clutch 36 is switched to the engaged condition. Accordingly, when the driving mode is changed by the driver's operation, the disconnection control of LU clutch 36 that prioritizes the driver's operation is performed, so that the driver's uncomfortable feeling can be reduced.

According to the electronic control unit 80 of the present embodiment, when the automated drive control unit 88 that controls the automated driving and LU clutch 36 is in an engaged state during the automated driving, the automated driving includes an predicted attainment period calculation unit 94 that calculates an inter-vehicle distance predicted attainment period Td or a vehicle speed predicted attainment period Tv until the inter-vehicle distance D or the vehicle speed V reaches the target inter-vehicle distance Dt or the target vehicle speed Vt, and a first connection/disconnection control unit 92 that performs control to continue the engagement state of LU clutch 36 when the inter-vehicle distance predicted attainment period Td or the vehicle speed predicted attainment period Tv is larger than a preset target attainment period Tg and to switch LU clutch 36 to the release state and when the inter-vehicle distance D or the vehicle speed V is equal to or smaller than the target attainment period Tg. Accordingly, when it is predicted that the target inter-vehicle distance Dt or the target vehicle speed Vt cannot be attained within the target attainment period Tg, LU clutch 36 is switched to the released state, so that the driving force is increased by the torque amplifying action of the torque converter 20 and the attainment period is shortened. Therefore, during automated driving, the connection/disconnection control of LU clutch 36 is optimally performed.

According to the electronic control unit 80 of the present embodiment, when the driving mode is changed to the eco-driving mode in which the driving force is reduced during the automated driving and when LU clutch 36 is in the released state, LU clutch 36 is switched to the engaged state. The second connection/disconnection control unit 96 may be further configured to control LU clutch 36 to continue to be released when the driving force is changed to the sporting mode or the power mode. Accordingly, when the driving mode is changed by the driver's operation, the disconnection control of LU clutch 36 that prioritizes the driver's operation is performed, so that the driver's uncomfortable feeling can be reduced.

It should be noted that the above-described embodiments of the present disclosure are examples of the present disclosure, and the present disclosure can be implemented in various modifications and improvements based on the knowledge of a person skilled in the art without departing from the gist thereof.

What is claimed is:

1. A control device for a vehicle equipped with a torque converter with a lockup clutch, the control device comprising:
an automated drive control unit that controls travelling by automated driving;
a predicted attainment period calculating unit that, when the vehicle is undergoing the travelling by automated driving and also the lockup clutch is in an engaged state, calculates a predicted attainment period required for an inter-vehicle distance to a vehicle traveling ahead or a vehicle speed to attain a target inter-vehicle distance or a target speed; and
a first engaging and disengaging control unit that performs control to switch the lockup clutch to a disengaged state when the predicted attainment period is greater than a target attainment period that is set in advance, and to maintain the engaged state of the lockup clutch when the predicted attainment period is no greater than the target attainment period.

2. The control device according to claim 1, further comprising a second engaging and disengaging control unit that performs control of,
when the vehicle is undergoing the travelling by automated driving and also the lockup clutch is in a disengaged state, and a traveling mode is changed to a setting for reducing driving force, switching the lockup clutch to the engaged state, and
when changed to a setting for increasing the driving force, maintaining the lockup clutch in the engaged state.
